(19) United States
(12) Patent Application Publication
(10) Pub. No.: US 2025/0379764 A1
(43) Pub. Date: Dec. 11, 2025

(54) POWER SCHEDULING FOR POWER OVER ETHERNET

(71) Applicant: CISCO TECHNOLOGY, INC., San Jose, CA (US)

(72) Inventors: Howard Haifeng ZHANG, Beijing (CN); Srikar Chaitanya NISTALA, Hyderabad (IN); Richa DAGA, New Delhi (IN); Ruchi AGRAWAL, Bangalore (IN); Poojalakshmi D, Karnataka (IN); Vinay SAINI, Bengaluru (IN)

(21) Appl. No.: 18/737,173

(22) Filed: Jun. 7, 2024

(51) Int. Cl. H04L 12/40; H04L 12/10

(52) U.S. Cl. CPC H04L 12/40045; H04L 12/10

(57) ABSTRACT

In one embodiment, a method includes: receiving a request from a powered device to schedule one or more power slots for delivery of additional power from power sourcing equipment to the powered device, the request including a requested amount of additional power, a requested time, and a requested duration, the additional power being an amount of power above a base level of power being supplied to the powered device; determining an availability of the amount of additional power at the requested time and for the requested duration; transmitting, in response to determining that the amount of additional power at the requested time and for the requested duration is available, a response indicating the availability; receiving at the requested time a confirmation request for the additional power from the powered device; and enabling the additional power to be supplied to the powered device in response to the confirmation request.

### FIELD

The present disclosure relates generally to power management systems and more particularly to power scheduling for Power over Ethernet (POE).

### BACKGROUND

Wireless charging for devices is becoming increasingly popular. The WiFi8 standard is developing a capability enabling the wireless charging of endpoints via native WiFi signals using charging frames from a wireless access point (AP). While the AP typically uses a fixed amount of power for regular operation, supporting wireless charging uses extra power from the switch. However, the AP cannot request additional PoE (Power over Ethernet) from the switch.

Accordingly, it is desirable to provide improved methods and systems for allowing the AP to communicate a need for additional power to the PoE device. Furthermore, other desirable features and characteristics of the present disclosure will become apparent from the subsequent detailed description and the appended claims, taken in conjunction with the accompanying drawings and the foregoing technical field and background.

### DRAWINGS

In order that the disclosure may be well understood, there will now be described various forms thereof, given by way of example, reference being made to the accompanying drawings, in which:

FIG. 1 is a block diagram of a PoE system providing power scheduling in accordance with various embodiments;

FIG. 2 is a diagram illustrating time slots for power scheduling in accordance with various embodiments;

FIG. 3 is a table illustrating different capabilities for power scheduling in accordance with various embodiments;

FIG. 4 illustrates an information string for a communication protocol in accordance with various embodiments;

FIG. 5 is a diagram illustrating a process flow for power scheduling in accordance with various embodiments;

FIG. 6 is another diagram illustrating a process flow for power scheduling in accordance with various embodiments;

FIG. 7 is another diagram illustrating a process flow for power scheduling in accordance with various embodiments;

FIG. 8 is another diagram illustrating a process flow for power scheduling in accordance with various embodiments; and

FIGS. 9A-9C are another diagram illustrating a process flow for power scheduling in accordance with various embodiments.

### DESCRIPTION OF EXAMPLE EMBODIMENTS

The following description is merely exemplary in nature and is not intended to limit the present disclosure, application, or uses. It should be understood that throughout the drawings, corresponding reference numerals indicate like or corresponding parts and features. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

### Overview

According to various embodiments, systems, methods, and computer program products are provided for managing power for PoE, such as power scheduling for wireless charging applications using PoE. A method includes receiving, by a processor at a network device, a request from a powered device to schedule one or more power slots for delivery of additional power from power sourcing equipment to the powered device, the request including a requested amount of additional power, a requested time, and a requested duration, the additional power being an amount of power above a base level of power being supplied to the powered device; determining, by the processor at the network device, an availability of the amount of additional power at the requested time and for the requested duration; transmitting, by the processor at the network device and in response to determining that the amount of additional power at the requested time and for the requested duration is available, a response indicating the availability; receiving, by the processor at the network device, at the requested time a confirmation request for the additional power from the powered device; and enabling, by the processor at the network device, the additional power to be supplied to the powered device from the power sourcing equipment in response to the confirmation request.

### Example Embodiments

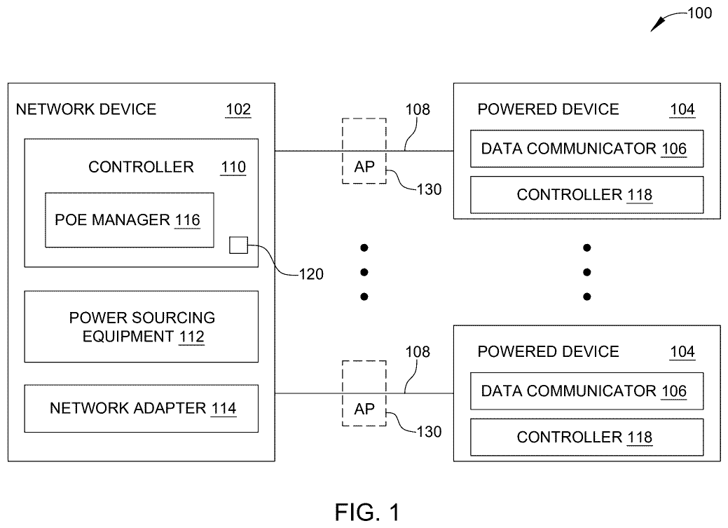

With reference to FIG. 1, a PoE system 100 is illustrated that in one or more embodiments includes a network device 102, such as a POE switch, and powered devices (PDs) 104. As shown, the network device 102 is coupled to the plurality of PDs 104, each of which represents any type of device capable of receiving DC power using PoE. For example, the PDs 104 may be consumer products, environmental controls, electronic devices, and the like. The PDs 104 each include a data communicator 106 that enables data communication via communication links, illustrated as Ethernet cables 108. That is, in one or more embodiments, the network device 102 enables the PDs 104 to communicate with a network (e.g., the Internet) as well as provide power to the PDs 104. Using the data communicators 106, the PDs 104 can receive data packets from, as well as transmit data packets to, the network device 102.

In some embodiments, the PoE system 100 is part of, for example, the Internet of Everything (IoE) or the Internet of Things (IoT). For example, the PD 104 may be a wireless charging device in a home. The network device 102 may include an application that turns the wireless charging device on and off based on a charge request. The PD 104, however, can be any type of device, such as any type of IoT device, for example a home sensor (e.g., humidity sensor), etc.

Although FIG. 1 illustrates that the network device 102 and PDs 104 transmitting data messages over the Ethernet cables 108, in some embodiments the network device 102 may provide only power to the PDs 104 using PoE. Further, instead of the network device 102 (e.g., a router, switch, etc.), a midspan device may be used to provide DC power and forward data packets to the PDs 104.

The network device 102 further includes a controller 110, power sourcing equipment (PSE) 112, and a network adapter 114. The controller 110 in some examples may be any OS capable of performing the functions described herein, such as to manage PoE requests using power scheduling. The controller 110 may establish a data plane for forwarding data between devices connected to the network device 102. The controller 110 may maintain a control plane to manage the flow of the data traffic in the data plane.

In various embodiments, the controller 110 includes a PoE manager 116 for performing PoE functions in the network device 102. For example, the PoE manager 116 may perform one or more PoE functions to allocate the power supplied by the PSE 112 among the PDs 104. In one or more embodiments, the PoE manager 116 allows any device (e.g., one of the PDs 104) to communicate a need for extra power from the network device 102 at specified times, which is then scheduled as described in more detail herein. In various embodiments, the network device 102 is configured as a PoE switch to control the power scheduling to satisfy the power requirements of the PDs 104. It should be noted that in some embodiments, the power scheduling is performed using a controller having the PoE manager 116.

The PSE 112 in some examples includes a physical power supply that is controlled by the PoE manager 116 to deliver power to the PDs 104. The PSE 112 may include an AC-DC converter that converts the AC power into DC power. As shown, the PSE 112 provides DC power to each of the PDs via the Ethernet cables 108. However, wireless transmission is contemplated within the PoE system 100 in one or more embodiments (such as for wireless charging), wherein the PDs 104 are associated with one or more access points (APs) 130. The PSE 112 may include circuitry for monitoring the power drawn by each of the PDs 104 to ensure the PDs 104 do not draw more power than the PDs 104 are allotted. The power supply (or supplies) in the PSE 112 may have a maximum, total power capacity (e.g., a total power budget) that can be allocated by the PoE manager 116 to the PDs 104. In addition to this total power limitation, a per PD power limit may be enforced. That is, the PSE 112 may provide up to a maximum power allotment to any one of the PDs 104, such as based on scheduling requirements as described in more detail herein. For example, even though the PSE 112 has a total power capacity of 100 W, the PoE manager 116 may be configured to allocate up to 30 W of power to each PD 104, which may be varied based on power scheduling. Otherwise, if each PD 104 was allocated the maximum power allotment, at most three PDs 104 could be powered by the network device 102 (with 10 W remaining).

As discussed below, the PDs 104 and the PoE manager 116 can use a scheduling process to dynamically change the power allocation presently supplied, as well as to be supplied in the future. For example, if the PoE manager 116 initially allocates a predefined power allotment (based power) to a PD 104, once powered on, the PD 104 can also schedule a higher (or lower) power allotment. This scheduling thereby changes the available power budget of the PSE 112 across the total number of PDs 104 that can be powered by the PSE 112.

In addition to providing power on the Ethernet cables 108, the network adapter 114 may transmit and receive data signals on the cables 108, such as power scheduling requests. Thus, the network device 102 may mix the data signal with power signals in order to simultaneously deliver power and data messages to and from the PDs 104 using the cables 108. However, in other embodiments, the cables 108 may be used to deliver only power, but not data, to the PDs 104. In some embodiments, network data is sent over one set of wires within the cable 108 and power is sent over a separate set of wires within the cable 108.

In one or more embodiments, the PoE manager 116 may improve operations performed using one of the PoE functions detailed in the IEEE 802.3at or 802.3bt standards to renegotiate power in smaller increments (e.g., one-tenth of a-watt increments), including to dynamically schedule the power supply to various devices (e.g., the PDs 104), such as to satisfy a present or future on-demand need for power. That is, in one or mor embodiments, the PoE manager 116 uses a scheduling algorithm as described in more detail herein that allows dynamic changes to power scheduling, thereby allowing dynamic changes to the power budget for the PSE 112. As a result, in various embodiments, the power budget is managed and not limited based to a first come, first reserve mode of operation.

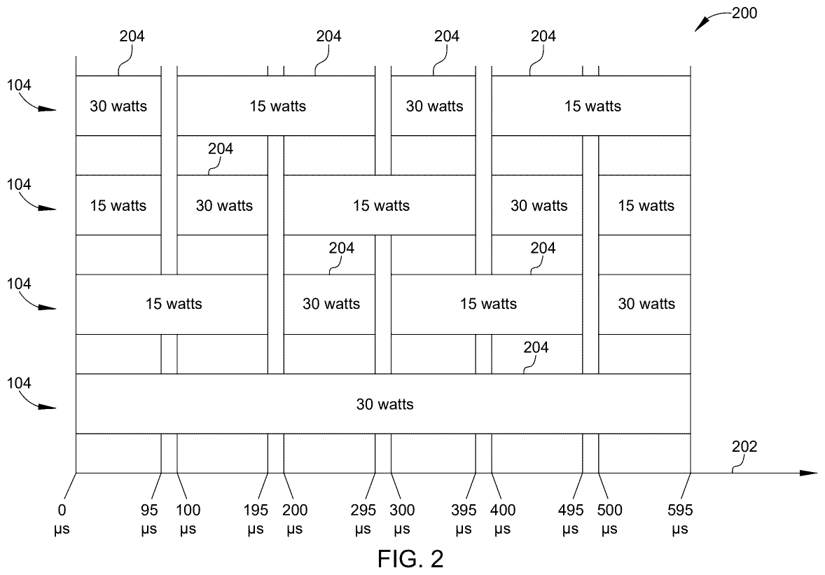

For example, in one or more embodiments, each of the PDs 104 includes a controller 118 that receives and processes network data signals from the network adapter 114. The controller 118 also sends signals to the network device 102, such as power scheduling requests as described in more detail herein. For example, the controller 118 communicates with the controller 110 to request changes in power allocation from the PSE 112, such as a determined or predicted need for power in the future. Based on a power allocation schedule 200 (see FIG. 2), the PoE manager 116 in various embodiments dynamically manages and/or controls present and future power allocation to the PDs 104. It should be noted that each of the PDs 104 may have one or more operational features, such as facilitating wireless charging in some examples.

The controller 110 and/or the controller 118, as well as other components of the PoE system 100 can include one or more processors or computing devices. The processors or computing device may be implemented using any suitable processing system, such as one or more processors, controllers, microprocessors, microcontrollers, processing cores and/or other computing resources spread across any number of distributed or integrated systems, including any number of “cloud-based” or other virtual systems. In various embodiments, computer-executable programming instructions are provided that, when read and executed by the controller 110, 118, cause the controller 110, 118 to perform power management and/or power scheduling for PoE as described in more detail herein.

The operating system in some examples includes computer-executable programming instructions, when read and executed by the processor, cause the processor to operate the server system's basic functions such as scheduling tasks, executing applications, memory allocation, and controlling the input/output devices. The input/output devices generally represent the interface(s) to networks (e.g., any other local area, wide area, or other network), mass storage, display devices, data entry devices, and/or the like.

In one or more examples, the network device 102 further includes memory 120 that stores data for power scheduling as described in more detail herein. For example, the memory 120 stores a power schedule table 510 as described in more detail herein. It should be noted that the memory 120, while shown as part of the controller 110, may form part of other components or devices, such as the PoE manager 116 and the controller 118, among others. Additionally, the memory 120 can include multiple memory devices provided in connection with one or more of the components of the PoE system 100.

It is to be appreciated that the memory 120 (e.g., a data store) can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The memory 120 of the subject systems and methods is intended to comprise, without being limited to, these and any other suitable types of memory. In addition, it is to be appreciated that the memory 120 can be a server, a database, a hard drive, and the like.

The memory 120 in various example represents any non-transitory short-or long-term storage or other computer-readable media capable of storing programming instructions for execution on the processor, including any sort of random access memory (RAM), read only memory (ROM), flash memory, magnetic or optical mass storage, and/or the like.

In various embodiments, the memory 120 includes databases that store data for use as described herein. As can be appreciated, the memory 120 represents one suitable implementation of such computer-readable media, and alternatively or additionally, the controller 110, 118 can receive and cooperate with external computer-readable media that is realized as a portable or mobile component or application platform, e.g., a portable hard drive, a USB flash drive, an optical disc, or the like.

With reference now also to FIG. 2, an example of the power allocation schedule 200 is shown. In this example, the maximum power supply capacity for the PSE 112 is 100 W. However, it should be appreciated that different power supply capacities may be provided by the PSE 112, and additional PSEs 112 also may be provided and included in the power scheduling using the power allocation schedule 200. As can be seen, the power allocation schedule 200 illustrates power scheduling for four PDs 104. However, the power allocation schedule 200 can be implemented in connection with any number of PDs 104. Also, while the power allocation schedule 200 illustrates power allocation at two different levels (15 watts and 30 watts), additional or different power levels can be scheduled using the power allocation schedule 200 and the illustrated values are merely for example. That is, as described herein, different additional amounts of power can be requested.

The power allocation schedule 200 is dynamically adjusted in various embodiments based on one or more power scheduling requests (which include prioritization in some examples) from the one or more PDs 104, which can communicate, for example, a need for extra or additional power in the future (e.g., additional power for wireless charging). The PoE manager 116 in various embodiments intelligently manages and schedules power to the PDs 104 using the power allocation schedule 200. That is, the PoE manager 116 is configured to allow for dynamic PoE allotment, including power scheduling based on requests for power in the future from one or more of the PDs 104. Thus, the PDs 104 are able to efficiently operate in different power modes based on current and future power demands. As can be seen in the power allocation schedule 200, power slots 204 can be dynamically assigned based on present and future power demands or requirements, and which may have different time lengths as shown along a timeline 202.

For example, the power allocation schedule 200 divides scheduling time into the various time slots 204 (also referred to as power slots). In various embodiments, the time slot 204 is an interval of time, synchronized between the PSE 112 and the PDs 104. In one or more embodiments, the time slots 204 do not overlap. Each time slot 204 may be the same time in length in some examples, with additional power provided using additional time slots 204.

It should be understood that there may be different kinds of time slots 204. For example, there may be a system-level time slot, which is the shortest amount of time at which the PoE system 100 can alternate power levels. For example, if the PoE system 100 is able to synchronize various components to within 10 ns of each other, a longer period of time, such as, for example, 1 μs, might be used as a system-level time slot, to allow devices time to respond to events. In addition, another type of time slot may be an application-level or device-level time slot that is a longer period of time made up of any number of system time slots. A device-level time slot in some examples is selected to allow a particular device to change power levels, but also to be short enough to allow for any latency requirements of the device or application. It should be understood that while system-level time slots do not overlap and are of uniform length in some examples, device-level time slots may vary in length between various devices executing different applications in some examples.

In one or more embodiments, a buffer interval interposes between each time slot 204. Thus, for example, the buffer interval, as shown in FIG. 2, may be five us. The buffer interval allows one PD 104 to ramp down power draw in anticipation of a lower allocation in the following time slot 204, so that if a different PD 104 changes from a lower-power mode to a higher-power mode (e.g., to accommodate wireless charging) in the next or future time slot 204, the momentary power usage does not exceed one or more power specifications. The buffer interval may be selected based on a power-transition specification for a particular device or set of devices.

In some examples, the PoE manager 116 manages the power allocation schedule 200 as a negotiation and scheduling mechanism, through which access points are capable of providing the “Wi-Fi charging” and can request additional power that is available upstream via PoE. That is, the PDs 104 are able to request a change in power requirements to the PSE 112, with the PoE manager 116 then performing scheduled power delivery as described in more detail herein. As such, the PDs 104 can request higher power even when the PSE 112 currently does not have the required power supplied for operation. In some embodiments, for example, when the power is in limited supply and the number of devices requiring this power for a short time period increases or is large, power requests can be made by the PDs 104 and allotted with available future power slots 204 in the absence of required power at the time of the request. In operation, the PDs 104 can thereby send request(s) for additional power at a proposed time slot for additional power.

As described in more detail herein, the power allocation schedule 200 allows the request to be made by the PDs 104, with a tentative time for which additional power is required in some examples. This tentative request is considered by the PoE manager 116 when scheduling subsequent additional power requests by the PDs 104 (e.g., to optimize an overall power budget). It should be noted that while this example (use-case) of dynamic power needs is for WiFi charging, the herein described power scheduling and management can be used with any PD 104 that needs to schedule additional PoE at certain intervals and specific duration(s).

In one or more embodiments, it is assumed that the PDs 104 are already being supplied with a required base level of power (e.g., a mandatory power) needed for basic operations (which may be done, for example, through PoE analog negotiation or using a Link Layer Discovery Protocol (LLDP) PoE negotiation). Additionally, in various examples, the PDs 104 are able to receive additional power and the PSE 112 has the capability to supply the additional power to one or more of the PDs 104. The PoE manager 116 in one or more embodiments uses a scheduling algorithm as described below. In particular, while requesting initial power, the PD 104 indicates an intent to request additional power on demand. In some embodiments, this request is made by adding a Type, Length, Value (TLV) in the LLDP frames. In some embodiments, the request includes the following parameters:
1. PD REQUEST ID: (Comprises a PD ID and Request ID) to be maintained in the power allocation schedule 200 or other scheduling table.
2. REQUESTED ADDITIONAL POWER: XX watts.
3. REQUESTED ADDITIONAL POWER AT A TIME: This can be relative to the present time (e.g., after 30 seconds, or now—present time).
4. REQUEST ADDITIONAL POWER FOR A TIME DURATION:

Defines how long the power is needed (e.g., a duration ranging from a few milliseconds to a few hours).

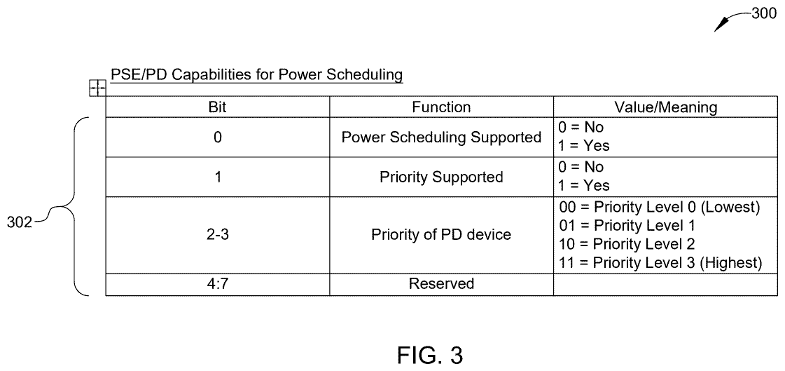

In some examples, a table is created in the PSE 112 that stores the additional power requests by the PDs 104. The table in one or more examples includes the following columns-the Identifier of the PD, the amount of additional power requested, the time delta at which the power is needed, the amount of time the additional power is needed and PD priority. In operation, the TLV alerts the PSE 112 to reserve additional power for such requests. FIG. 3 illustrates an example of a table 300 that shows an example of a capability discussion between one or more of the PDs 104 and the PSE 112 before enabling scheduling. As can be seen, different bits can be used for identifying different functionalities 302, such as whether power scheduling is supported, whether priority is supported for the PD 104, and a priority level for the PD 104. Thus, in various embodiments, different bits are used to allow for the dynamic request and allotment of future power requirements based on one or more functionalities of the PDs 104.

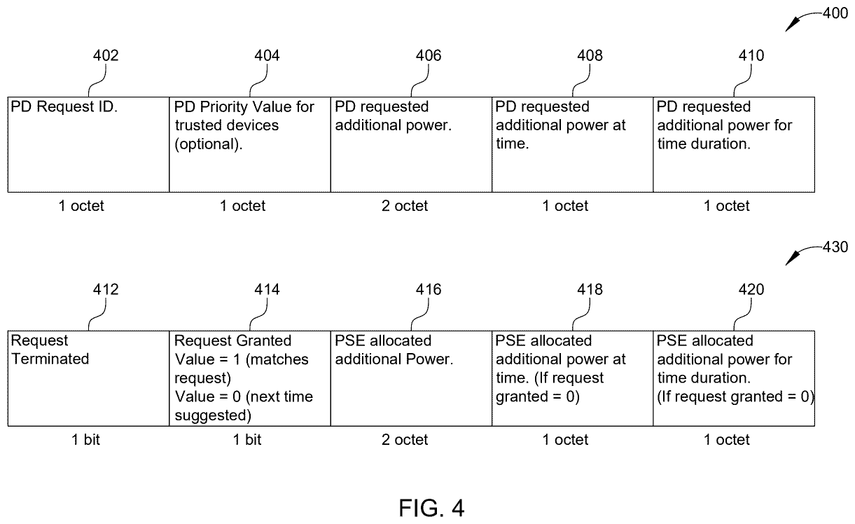

A TLV string is generated in various examples with FIG. 4 illustrating an example of TLV information strings 400 and 430 for the LLDP protocol. As can be seen, in this example, for the string 400, a PD Request ID is provided using an octet 402,

PD priority values are optionally provided using an octet 404 (e.g., priority values for trusted devices), the PD requested additional power is provided by octets 406, the requested time for the additional power is provided by octet 408, and the time duration for the additional power is provided by octet 410. And, for the string 430, the request termination is provided by octet 412, the request granted is provided by the octet 414, the additional power granted is provided by the octets 416, the granted time is provided by the octet 418, and the granted duration is provided by the octet 420. It should be noted that different units of information may be used, as well as providing different information.

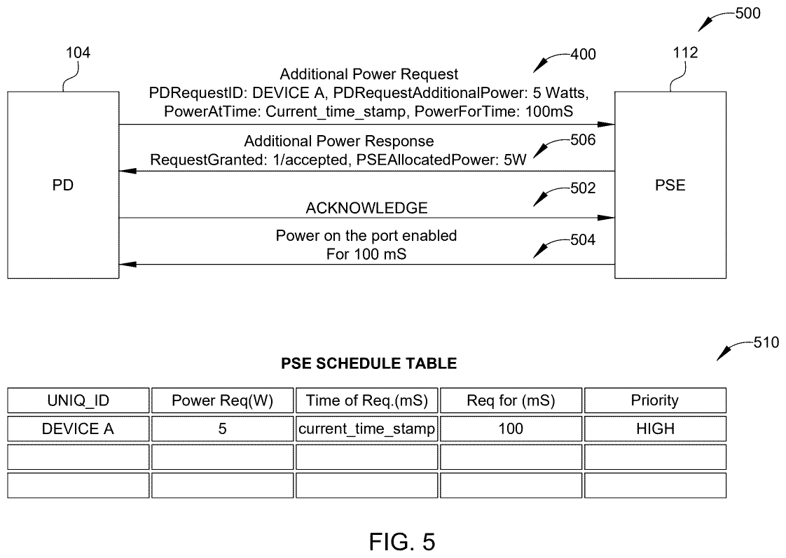

Various conditions of power requests will now be described as shown in FIGS. 5, 6, 7, 8, and 9A-9C for power scheduling. In particular, FIG. 5 illustrates a process flow 500 (e.g., data flow) relating to the PD 104 requiring immediate power and the PSE 112 does not have any available power to supply to the PD 104 and there is no conflict. In this example, if the PD 104 requires additional power immediately, the PSE 112 checks if the power required by the device is available and if there is currently no other PD 104 scheduled for power, an ACCEPT response is sent. The power can be delivered to the PD 104 for the requested and acknowledged duration. The PSE 112 adds the information to a power schedule table 510 with the current time slot allocated to the PD 104, namely identifying the PD 104 (using a Device ID (UNIQ_ID) and the current power request.

As can be seen, the TLV information string 400 is sent from the PD 104 to the PSE 112 with an additional available power response 506 sent back to the PD 104 from the PSE 112 that indicates power is available. The PD 104 sends an acknowledgement 502 to the PSE 112, which then sends a confirmation 504 that power on the port is enabled. In the example, the power schedule table 510 is generated that shows that the power request is a high priority, but the priority level is not needed as power is available from the PSE 112.

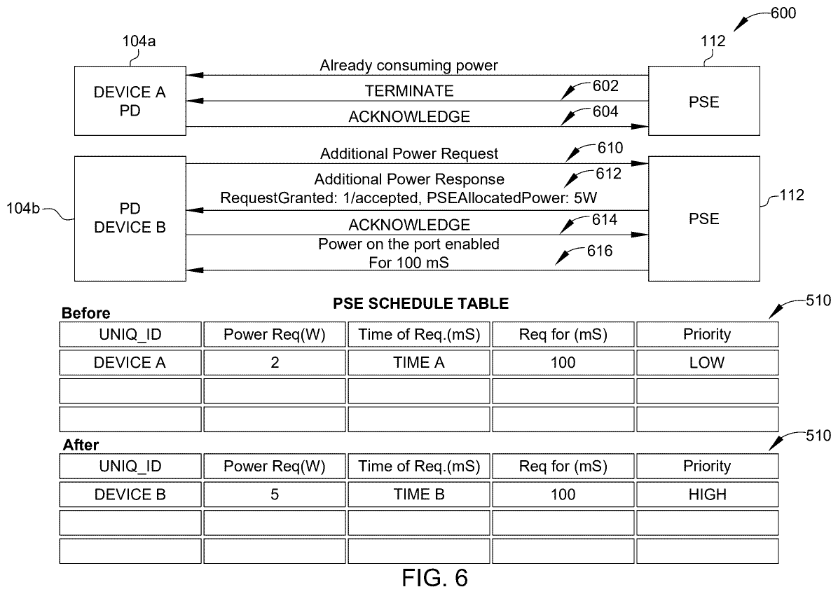

FIG. 6 illustrates a process flow 600 relating to the PD 104 requiring immediate power, but the PSE 112 has less power than requested or has no power to allocate. In this example, the PSE 112 first checks the priority of the PD 104, and if another PD 104 having a lower priority request is using the power, the PSE 112 sends a terminate additional power request to the lower priority device, namely the PD 104 having the lower priority and reallocates (e.g., diverts) the power to the PD 104 with the higher priority request.

In this example, the PD 104a illustrated as Device A (having a low priority as can be seen in the power schedule table 510) made a request at Time A for 100 milliseconds (ms) and the PSE 112 granted power based on this request. As such, the PD 104a is already receiving and consuming power. In response to the PD 104b illustrated as Device B (having a high priority as can be seen in the power schedule table 510) making a request at Time B (Time B<Time A+100 ms) for power during the allotted time slot of PD 104a, the PSE 112 sends a terminate request 602 to PD 104a and replaces the entry in the power schedule table 510 with PD 104b, including the requested TLV information.

As can be seen, in response to an additional power request 610 from the PD 104b to the PSE 112, and determining the higher priority device (in this example, the PD 104b), the terminate request 602 is sent, and the PD 104a sends an acknowledge signal 604, which causes the PSE 112 to transmit to the PD 104b an additional power response 612 based on the additional power request 610, which the PD 104 acknowledges with an acknowledge signal 614. The PSE 112 then sends a confirmation 616 that power on the port is enabled for the requested time period.

It should be noted that the information communicated between the PSE 112 and the PD 104a, 104b, can be configured as the TLV string 400, the TLV string 430, or portions thereof. It should also be noted that the priority of the PDs 104 can be defined using any priority scheme or criteria. In various embodiments, the priority defines the precedency in allocating additional power to a device by the PSE 112 when there is a conflict of time or there is a limited power budget. The priority can be set for the switch port itself, or such a value can be shared by the PD 104. For example, access points can have a central priority assigned by a Wireless LAN Controller (WLC)/Digital Network Architecture Center (DNAC).

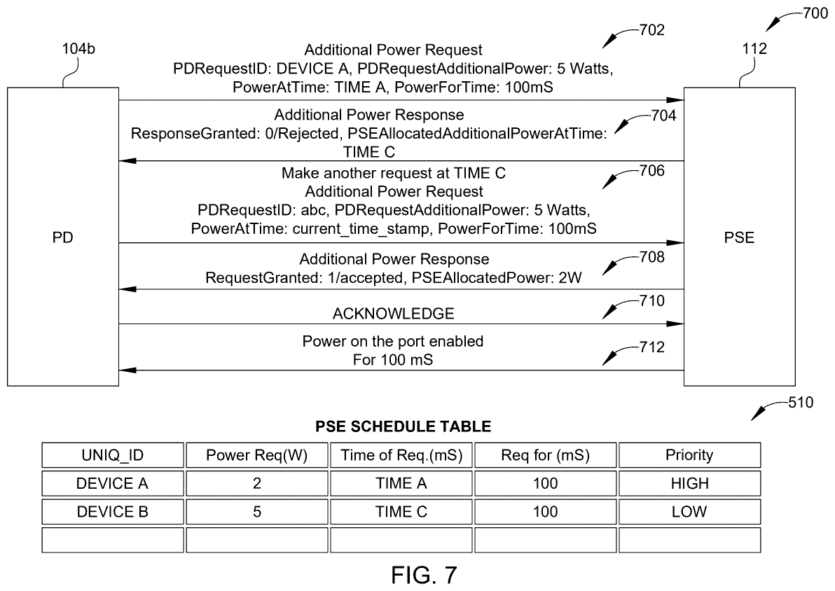

FIG. 7 illustrates a process flow 700 relating to the PD 104a having the lower priority requesting immediate power while the PSE 112 is providing power to the PD 104b having the higher priority. In this example, the PSE first checks the priority of the PDs 104, and if a higher priority request (e.g., a request from the PD 104b being a prior powered device) is using the power, the PSE 112 sends an allocation of the next available slot to the PD 104b. The PSE 112 also modifies (e.g., adds the information) the power schedule table 510.

In this example, assume the PD 104a made a request for power at Time and the PSE 112 granted power. The PD 104b then makes a request at Time B (Time B<Time A+100 ms) for power during the allotted time slot of PD 104a. In response, the PSE 112 gives the PD 104a a time slot (e.g., the time slot 204) after the allotted time slot for PD 104a (at Time A+100 ms, indicated as Time C).

As can be seen, in response to an additional power request 702 from the PD 104 (namely the PD 104a), the PSE 112 provides an additional power response 704 allocating this lower priority device a later time slot. That is, the PoE manager 116 performs scheduling for future time slots, in this example, for the PD 104a after the presently allocated time slots for the higher priority device have been used. The PD 104a then makes another additional power request 706 with the PSE 112 providing a response 708 that is then acknowledged by the PD 104a with an acknowledge signal 710. The PSE 112 then sends a confirmation 712 that power on the port is enabled for the requested future time period. The entries in the power schedule table 510 are updated with the power time slot allocations for the two PDs 104.

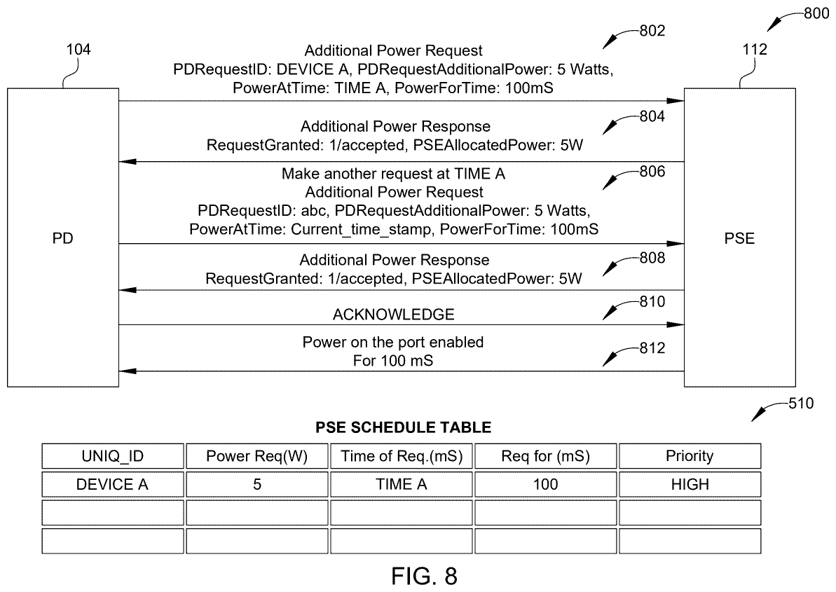

FIG. 8 illustrates a process flow 800 relating to the PD 104 requesting additional power in the future and there are no conflicts. In this example, the PSE 112 updates the power schedule table 510 with the scheduling information, which is stored for power management by the PoE manager 116. That is, the PD 104 replies to the request with an accept response and the time slot is scheduled (e.g., future allocation to the PD 104).

As can be seen, in response to an additional power request 802 from the PD 104, the PSE 112 provides an additional power response 804 allocating the future time slot (Time A). Essentially, the future time slot is “reserved” for power allocation of the PD 104 (assuming a higher priority request is not received before the time slot or there are no other changes to the power slot allocations). In this example, at the scheduled time (Time A), the PD 104 makes another request for the power, namely makes an additional power request 806 (conformation request) to confirm that the time slot is still available with the PSE 112 providing a response 808 that is then acknowledged by the PD 104 with an acknowledge signal 810. The PSE 112 then sends a confirmation 812 that power on the port is enabled for the time period that was previously requested by the PD 104. The entry in the power schedule table 510 is unchanged as the future time slot, was confirmed, thereby becoming the present time slot.

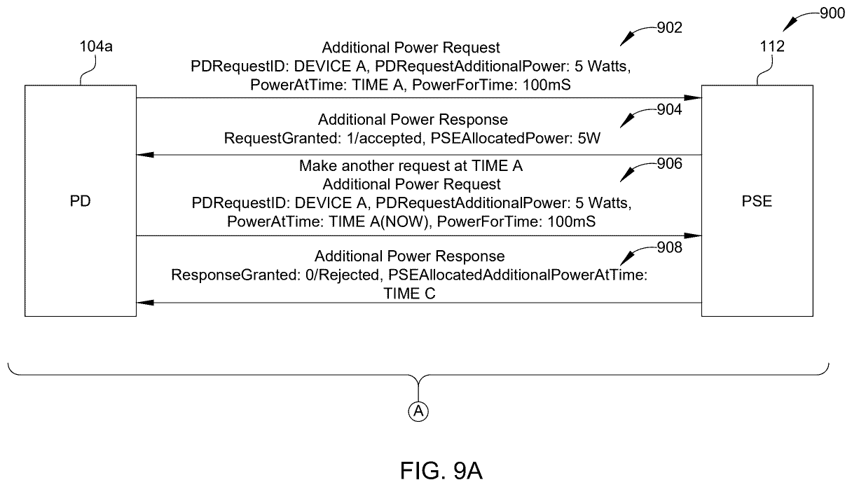

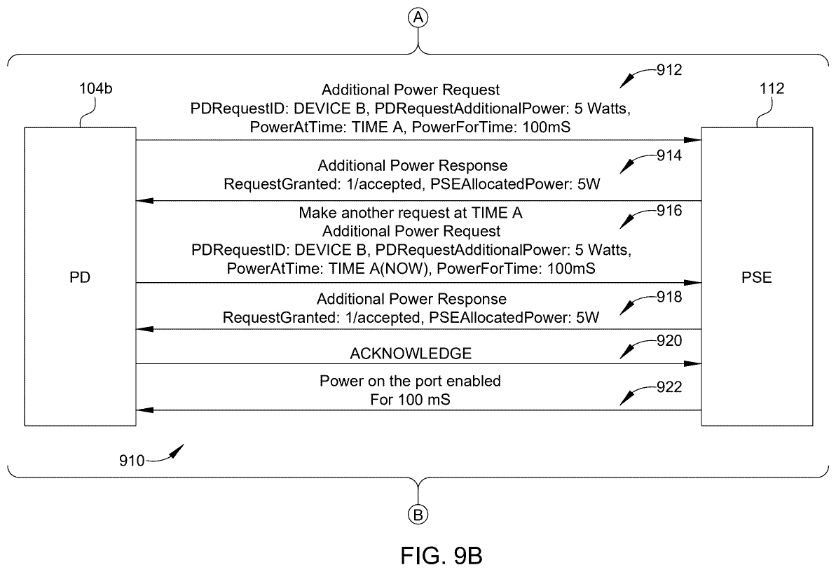

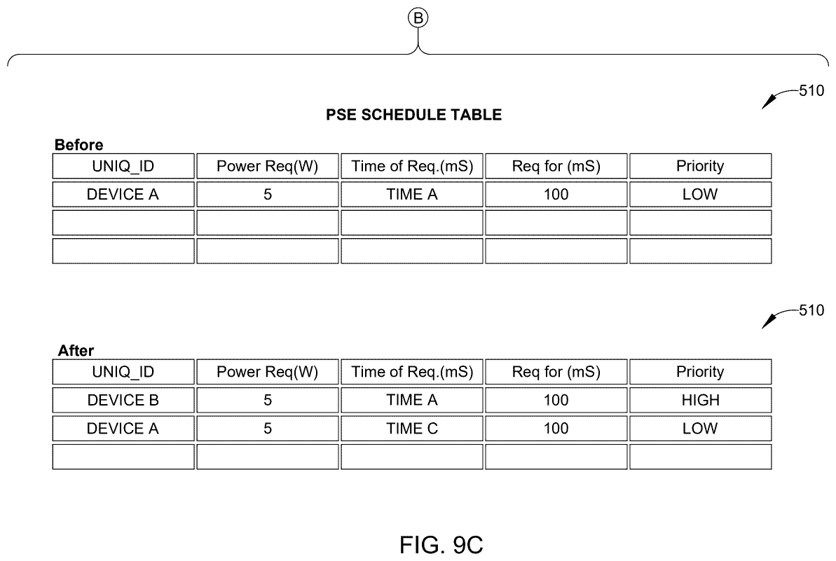

FIGS. 9A-9C illustrate a process flow 900 relating to the PD 104 requesting additional power for a future time slot and the time slot is already allocated (e.g., there is already an entry at the same slot in the power schedule table 510). In this example, the PSE 112 determines the priority of the request and the priority of the allocated slot having the conflict, and if the new request has a lower priority, the PSE 112 sends a reject response along with an indication of a new available time slot. The PD 104 is then able to accept the new available time slot and make the confirmation request at a time of the new available time slot.

As can be seen, in response to an additional power request 902 from the PD 104a to the PSE 112, the PSE 112 sends an additional power response 904 rejecting the request and indicating an available future time slot. That is, the future time slot request by the PD 104a is already allotted (scheduled in the future) to a higher priority device (e.g., the PD 104b). The PD 104a, at that future time, if the PD 104a still needs the power, makes another additional power request 906 to the PSE 112, with an additional power response 908 returned by the PSE 112 confirming that the slot is still available.

FIGS. 9A-9C also illustrate a process flow 910 relating to the PD 104 requesting additional power for a future time slot and the time slot is already allocated (e.g., there is already an entry at the same slot in the power schedule table 510). In this example, the PSE 112 determines the priority of the request and the priority of the allocated slot having the conflict, and if the new request has a higher priority than the priority of the time slot having the conflict, the PSE 112 reallocates the time slot to the higher priority device (e.g., the PD 104b) and replaces the record in the power schedule table 510 (as illustrated by the Before and After states of the power schedule table 510).

In this example, assume the PD 104b makes the request during the time slot allocated to the PD 104a at Time B. The time slot allocated to the PD 104a is relocated or reassigned to the PD 104b, such that when the PD 104a makes the confirmation request at Time B for the slot, the PSE 112 rejects the request and identifies a new available time slot.

More particularly, in response to an additional power request 912 from the PD 104b to the PSE 112, and determining the device as a higher priority device, the PSE 112 sends an acknowledge signal 914, which causes the PSE 112 to be assigned the time slot at Time A. The PD 104b at Time A makes another additional power request 916 to confirm that the PD 104b intends to use the time slot and the PSE sends an additional power response 918, which is acknowledged by the PD 104b with an acknowledge signal 920. The PSE 112 then sends a confirmation 922 that power on the port is enabled for the requested time period Time A (which was previously reallotted from the PD 104a to the PD 104b). The PD 104a makes a similar confirmation request at Time C, which is the reallotted or reassigned time slot for this lower priority device.

Thus, one or more embodiments provide dynamic power scheduling, including allotment of future time slots for use in providing additional power.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for power scheduling, the method comprising:
receiving, by a processor at a network device, a request from a powered device to schedule one or more power slots for delivery of additional power from power sourcing equipment to the powered device, the request including a requested amount of additional power, a requested time, and a requested duration, the additional power being an amount of power above a base level of power being supplied to the powered device;
determining, by the processor at the network device, an availability of the amount of additional power at the requested time and for the requested duration;
transmitting, by the processor at the network device and in response to determining that the amount of additional power at the requested time and for the requested duration is available, a response indicating the availability;
receiving, by the processor at the network device, at the requested time a confirmation request for the additional power from the powered device; and
enabling, by the processor at the network device, the additional power to be supplied to the powered device from the power sourcing equipment in response to the confirmation request.

2. The method of claim 1, further comprising storing data for the requested amount of additional power, the requested time, and the requested duration in a power schedule table in combination with a device ID for the powered device and one or more allotted time slots corresponding to the requested time and the requested duration.

3. The method of claim 1, wherein the request from the powered device to schedule one or more power slots for delivery of additional power is defined in a Type, Length, Value (TLV) data string in one or more Link Layer Discovery Protocol (LLDP) frames transmitted by the powered device.

4. The method of claim 1, wherein the request from the powered device to schedule one or more power slots for delivery of additional power is generated by an access point associated with the powered device, and wherein the access point is capable of wireless charging of the powered device.

5. The method of claim 1, further comprising determining, by the processor at the network device, a priority for the request from the powered device, in response to the powered device being identified as a trusted device.

6. The method of claim 5, further comprising, reallotting, by the processor at the network device, the one or more power slots to the powered device making the request based on the powered device having a higher priority than a prior powered device having previously been assigned the one or more power slots, and assigning the prior powered device a different one or more power slots, such that the one or more power slots become available for the powered device.

7. The method of claim 1, wherein the requested time is a current time, and in response to a maximum power budget of the power sourcing equipment being presently exceeded, further comprising allotting, by the processor at the network device, a next time slot to the powered device in response to the request, and terminating power being used by another powered device having a lower priority than the powered device in the next time slot, and reallotting the power to a future time slot, such that the next time slot becomes available for the powered device.

8. The method of claim 1, further comprising receiving, by the processor at the network device, requests from a plurality of powered devices to schedule one or more power slots for delivery of additional power from the power sourcing equipment to the plurality of powered devices, and optimizing an overall power budget for the power sourcing equipment based on a priority of each powered device of the plurality of powered devices and the availability of time slots identified using a power schedule table.

9. The method of claim 1, wherein the requested time is a tentative time and further comprising scheduling, by the processor at the network device, additional time slots for additional powered devices based at least in part on the tentative time.

10. The method of claim 1, wherein the response indicates availability at a different time and further comprising transmitting, by the processor at the network device, additional time slots for the different time to the powered device.

11. A system for power scheduling, comprising:
one or more processors;
a tangible computer-readable storage medium storing instructions which, when executed by the one or more processors, cause the one or more processors to:
receive a request from a powered device to schedule one or more power slots for delivery of additional power from power sourcing equipment to the powered device, the request including a requested amount of additional power, a requested time, and a requested duration, the additional power being an amount of power above a base level of power being supplied to the powered device;
determine an availability of the amount of additional power at the requested time and for the requested duration;
transmit, in response to determining that the amount of additional power at the requested time and for the requested duration is available, a response indicating the availability;
receive at the requested time a confirmation request for the additional power from the powered device; and
enable the additional power to be supplied to the powered device from the power sourcing equipment in response to the confirmation request.

12. The system of claim 11, wherein the tangible computer-readable storage medium is further configured to store instructions which, when executed by the one or more processors, cause the one or more processors to store data for the requested amount of additional power, the requested time, and the requested duration in a power schedule table in combination with a device ID for the powered device and one or more allotted time slots corresponding to the requested time and the requested duration.

13. The system of claim 11, wherein the request from the powered device to schedule one or more power slots for delivery of additional power is defined in a Type, Length, Value (TLV) data string in one or more Link Layer Discovery Protocol (LLDP) frames transmitted by the powered device.

14. The system of claim 11, wherein the request from the powered device to schedule one or more power slots for delivery of additional power is generated by an access point associated with the powered device, and wherein the access point is capable of wireless charging of the powered device.

15. The system of claim 11, wherein the tangible computer-readable storage medium is further configured to store instructions which, when executed by the one or more processors, cause the one or more processors to determine a priority for the request from the powered device, in response to the powered device being identified as a trusted device.

16. The system of claim 15, wherein the tangible computer-readable storage medium is further configured to store instructions which, when executed by the one or more processors, cause the one or more processors to reallot the one or more power slots to the powered device making the request based on the powered device having a higher priority than a prior powered device having previously been assigned the one or more power slots, and assigning the prior powered device a different one or more power slots, such that the one or more power slots become available for the powered device.

17. The system of claim 11, wherein the requested time is a current time, and in response to a maximum power budget of the power sourcing equipment being presently exceeded, the tangible computer-readable storage medium is further configured to store instructions which, when executed by the one or more processors, cause the one or more processors to allot a next time slot to the powered device in response to the request, and terminating power being used by another powered device having a lower priority than the powered device in the next time slot and reallotting the power to a future time slot, such that the next time slot becomes available for the powered device.

18. The system of claim 11, wherein the tangible computer-readable storage medium is further configured to store instructions which, when executed by the one or more processors, cause the one or more processors to receive requests from a plurality of powered devices to schedule one or more power slots for delivery of additional power from power sourcing equipment to the plurality of powered devices, and optimizing an overall power budget for the power sourcing equipment based on a priority of each powered device of the plurality of powered devices and availability of time slots identified using a power schedule table.

19. The system of claim 11, wherein the requested time is a tentative time and the tangible computer-readable storage medium is further configured to store instructions which, when executed by the one or more processors, cause the one or more processors to schedule additional time slots for additional powered devices based at least in part on the tentative time.

20. A computer-readable storage device storing instructions which, when executed by one or more processors, cause the one or more processors to:
receive a request from a powered device to schedule one or more power slots for delivery of additional power from power sourcing equipment to the powered device, the request including a requested amount of additional power, a requested time, and a requested duration, the additional power being an amount of power above a base level of power being supplied to the powered device;
determine an availability of the amount of additional power at the requested time and for the requested duration;
transmit, in response to determining that the amount of additional power at the requested time and for the requested duration is available, a response indicating the availability;
receive at the requested time a confirmation request for the additional power from the powered device; and
enable the additional power to be supplied to the powered device from the power sourcing equipment in response to the confirmation request.
